(19) United States
(12) Patent Application Publication
(10) Pub. No.: US 2007/0266085 A1
(43) Pub. Date: Nov. 15, 2007

(54) S-CSCF selection for application server originated requests

(75) Inventors: Zsolt Rajko, Lovasbereny (HU); Jozsef Varga, Nagydobsza (HU)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/790,914

(22) Filed: Apr. 27, 2007

Related U.S. Application Data
(60) Provisional application No. 60/795,582, filed on Apr. 28, 2006.
(60) Provisional application No. 60/838,899, filed on Aug. 21, 2006.

(51) Int. Cl. G06F 15/16

(52) U.S. Cl. 709/203

(57) ABSTRACT

A server includes a sending unit configured to send a location information request to a home server for querying a default server name and capabilities of a unregistered subscriber for whom the server is originating the location information request. The server also includes a processing unit, if the default server name is provided in a location information answer, configured to route the location information request to the default server name provided in the location information answer or configured to select a suitable function and the supported capabilities of the selected function. The server further includes an indicating unit configured to indicate in the location information request that the function should serve the location information request as an originating request.

### CROSS-REFERENCES TO RELATED APPLICATIONS

This application claims priority of U.S. Provisional Patent Application Ser. No. 60/795,582, filed on Apr. 28, 2006 and U.S. Provisional Patent Application Ser. No. 60/838,899, filed on Aug. 21, 2006. The subject matter of the above referenced applications is incorporated by reference.

### BACKGROUND OF THE INVENTION

1. Field of the Invention

The present invention relates to service request handing, and more particularly to a scenario where an application server initiates a request on behalf of a subscriber who is not registered with a IP subsystem.

2. Description of the Related Art

An IP system, for example, an IP multimedia subsystem (IMS), utilizes a Session Initiation Protocol (SIP) for initiating and controlling service requests. Procedures for handling request in IMS are currently defined and described, for instance, in 3GPP TS 23.228 and 24.229 specifications. Specifically, clause 5.65 of 3GPP TS 23.228 (version 7.2.0) specification defines a scenario when an application server initiates a request on behalf of a subscriber who is not currently registered to the IMS. One important example that uses this scenario is the voice call continuity call setup described in the 3GPP TR 23.806 (version 7.0.0) and TS 23.206 (version 0.3.0) specifications. In the voice call continuity scenario, when a call setup is initiated from a circuit switched domain, the call continuity function, which is an application server from the IMS point of view, is anchored to the call and it sends the session initiation request to the IMS on behalf of a calling subscriber who may or may not be registered to the IMS.

Clause 5.7.3 of 3GPP TS 24.229 (version 7.2.0) specification describes procedures in the application server for sending requests on behalf of a subscriber. According to current procedures, the application server sends the request to the Serving-Call Service Control Function (S-CSCF). The S-CSCF is an IMS element that provides the session control services for a mobile node, which enables a network operator to support the services. Functions provided by the S-CSCF include the management of mobile registrations, maintaining of the session, interaction with other services, charging and security. If the subscriber is registered to the IMS, then the application server learns the address of the S-CSCF where the user is registered, either from a third party registration procedure or by querying a home subscriber server. However, no solution is currently provided for the case where the subscriber is not registered in the IMS.

According to clause 5.6.5 of the 3GPP TS 23.228 specification, in cases of originating unregistered procedures, the S-CSCF in the home subscriber server will follow the same principles as currently defined for terminating unregistered user. However, as currently defined, to terminate a call to an unregistered user, it is necessary for the S-CSCF to have unregistered terminating services. Otherwise, the home subscriber server will not return capabilities for location query, and thus an Interrogating-Call Service Control Function (I-CSCF) will reject the request instead of forwarding it to a terminating S-CSCF. So even though call origination on behalf of a user can be done even if the user has no originating unregistered services at all, to terminate a call to unregistered user, it is necessary to have unregistered terminating services.

### SUMMARY OF THE INVENTION

An embodiment of the invention relates to a server including a sending unit configured to send a location information request to a home server for querying a default server name and capabilities of a unregistered subscriber for whom the server is originating the location information request. The server also includes a processing unit, if the default server name is provided in a location information answer, configured to route the location information request to the default server name provided in the location information answer or configured to select a suitable function and the supported capabilities of the selected function. The server further includes an indicating unit configured to indicate in the location information request that the function should serve the location information request as an originating request.

Another embodiment of the invention relates to an interrogating-call session control function including a receiving unit configured to receive a location information request including a public identity of an unregistered subscriber, the location information request being used to indicate an originating request. The interrogating-call session control function also includes a processing unit configured to query a home server for capability information for the subscriber associated with the public identity and a sending unit configured to send, upon receipt of a location information answer from the home server, the location information request to a default serving function or a selected serving function, depending on information provided in the location information answer in response to the location information request.

Another embodiment of the invention relates a method for sending, by an interrogation server, a location information request to a home server for querying a default server name and capabilities of an unregistered subscriber, receiving, by the interrogation server from the home server, a location information answer, routing, by the interrogation server, the location information request to the default server name provided in the location information answer, if the default server name is provided in the location information answer, and selecting, by the interrogation server, a suitable function that support the capabilities of the subscriber, if the default server name is not provided in the location information answer, wherein the interrogation server indicates in the location information request that the function should serve the location information request as on originating request.

Another embodiment of the invention relates to a method for receiving, by an interrogation function from an application server, a location information request including a public identity of the subscriber, the location information request being used to indicate an originating request, querying for a serving function for capability information for the subscriber associated with the public identity, and sending the location information request to a default serving function or a selected serving function depending on information provided in a location information answer in response to the location information request.

Another embodiment of the invention relates an apparatus including sending means for sending, by an interrogation server, a location information request to a home server for querying a default server name and capabilities of an unregistered subscriber, receiving means for receiving, by the interrogation server from the home server, a location information answer, routing means for routing, by the interrogation server, the location information request to the default server name provided in the location information answer, if the default server name is provided in the location information answer, and selecting means for selecting a suitable function that support the capabilities of the subscriber, if the default server name is not provided in the location information answer, wherein the interrogation server indicates in the location information request that the function should serve the location information request as on originating request.

Another embodiment of the invention relates an apparatus including receiving means for receiving, by an interrogation function from an application server, a location information request including a public identity of the subscriber, the location information request being used to indicate an originating request, querying means for querying, by the interrogation function, for a serving function for capability information for the subscriber associated with the public identity. and sending means for sending, by the interrogation function, the location information request to a default serving function or a selected serving function depending on information provided in a location information answer in response to the location information request.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates an embodiment of an IP Multimedia subsystem;

FIG. 2 illustrates steps implemented by a server implementing an embodiment of the invention; and

FIG. 3 illustrates steps implemented by the I-CSCF implementing an embodiment of the invention.

### DETAILED DESCRIPTION OF PREFERRED EMBODIMENTS

Reference will now be made to the preferred embodiments of the present invention, examples of which are illustrated in the accompanying drawings.

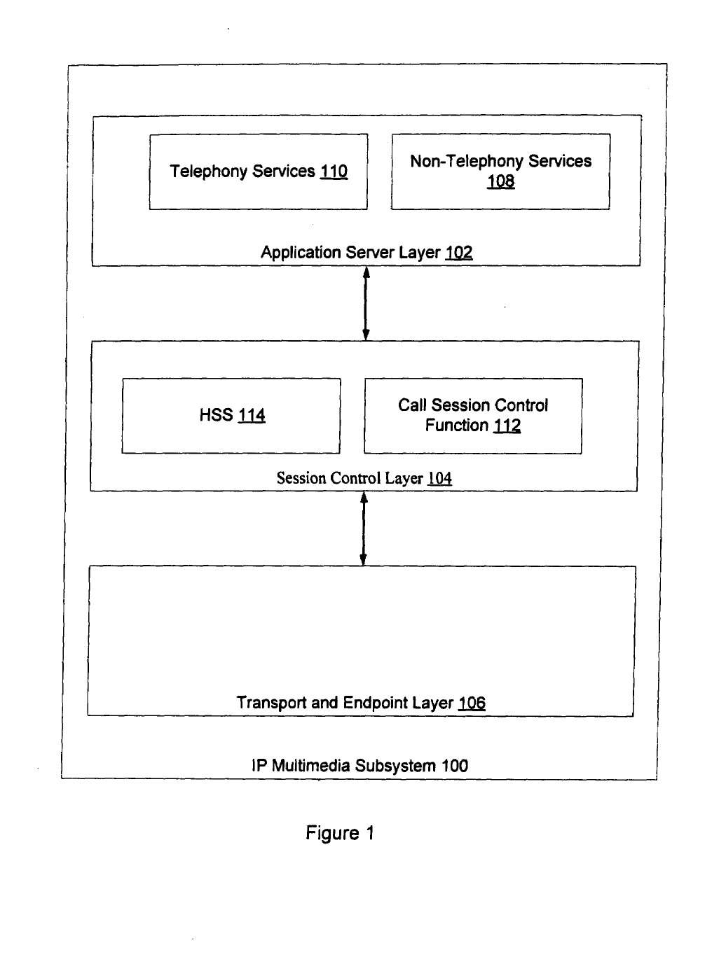

FIG. 1 illustrates an embodiment of an IP Multimedia subsystem 100 in which embodiments of the present invention may be implemented. Subsystem 100 includes an application server layer 102, a session control layer 104 and a transport and endpoint layer 106. Subsystem 100 is a unified architecture that supports a wide range of services enabled by the flexibility of a Session Initiation Protocol (SIP). As shown in FIG. 1, the subsystem 100 can support multiple application servers providing traditional telephony services 108 and non-telephony services 110, such as instant messaging, push-to-talk, and video streaming. Transport and endpoint layer 106 initiates and terminates SIP signalling to set up sessions and provide bearer services such as, conversion of voice from analog or digital formats to Internet Protocol (IP) packets using Realtime Transport Protocol (RTP). Session control layer 104 includes a Call Session Control Function (CSCF) 112, which provides the registration of endpoints and routing of SIP signalling messages to an appropriate application server. CSCF 112 interworks with transport and endpoint layer 106 to guarantee Quality of Service across all services. Session control layer 104 also includes a Home Subscriber Server (HSS) database 114 that maintains the unique service profile for each end user. The end user's service profile stores all of the user service information and preferences in a central location, including an end user's current registration information, roaming information, telephony services, such as call forwarding information, instant messaging service information, such as buddies list, and voice mail box options. Application server layer 102 includes the application servers, which provide the end-user service logic.

According to a first embodiment of the present invention, when the application server originates a request on behalf of an unregistered IMS subscriber, the application server sends a location information request message to the home subscriber server, through an existing Sh interface, for querying a default server name and the capabilities of the subscriber. It should be noted that the capabilities may be mandatory or optional. If the default server name is provided in a location information answer/response, then the request is routed to the default server name, otherwise, the application server selects, based on the received capabilities in the location information answer, a suitable Serving Call Session Control Function (S-CSCF) in the network and their supported capabilities. This information is configured to the application server. The application server indicates in the SIP message that the S-CSCF should serve the request as an “originating” request by putting an ORIG parameter to URI of the S-CSCF.

The 3GPP 29.228 (version 7.0.0) specification discloses procedures in the home subscriber server for responding to the location information request. According to current procedures, if the subscriber is not registered in the IMS, then the home subscriber server sends a Server-Capablities Attribute Value Pair (AVP), as required for S-CSCF selection, in the location information answer message only if unregistered services are provisioned for the user. This causes the application server's originating request to fail for such users who do not any services that should run in an unregistered state. As such, in a first solution implemented in the first embodiment of the present invention, the I-CSCF indicates to the home subscriber server, in a location information request message, that a location information query is being made for the originating request. If the subscriber, in this embodiment, is not registered to the IMS, then the home subscriber server provides the Server-Capabilities AVP in the location information response message, for such location information request message that includes an indication of the originating scenario, even if the subscriber does not currently have “originating” unregistered services. In a second solution implemented in the first embodiment of the invention, if the subscriber is not registered to the IMS, then the home subscriber server always provides the Server-Capabilities AVP in a location information response message, even if the subscriber does not have current unregistered services.

In a second embodiment of the invention, the application server sends the request to the I-CSCF and inserts a public identity of the subscriber in a P-Asserted-Identity header, as required by the disclosure of clause 5.7.3 of the 3GPP 24.229 specification. The application server indicates to the I-CSCF that this is an originating request. I-CSCF, recognizing that the originating request is being served, queries the home subscriber server for capability information for the subscriber indicated in the P-Asserted-Identity header of the SIP request. That is, I-CSCF sends the location information request message to the home subscriber server through a Cx interface using the identity from P-Asserted-Identity header, instead of a Request-URI as in a terminating case, to the Public-Identity AVP of Cx message. When the I-CSCF receives a response from the home subscriber server in the location information answer message, the I-CSCF either sends the request to the default S-CSCF or selects a S-CSCF based on the capabilities according to normal procedure. I-CSCF indicates in the SIP message that the S-CSCF should serve the request as an “originating” request, by placing an ORIG parameter to URI of S-CSCF. Alternatively, when the application server sends the SIP request to the I-CSCF, the application service adds and ORIG parameter to the URI of the I-CSCF that is added to the SIP message as the topmost route header.

Even in the second embodiment of the invention, the I-CSCF indicates to the home subscriber server in the location information request message that a location information query is being made for the originating request. If the subscriber, in this embodiment, is not registered to the IMS, then in a first solution implemented in the second embodiment, the home subscriber server provides Server-Capabilities AVP in a location information response message, for such location information request message that includes an indication of the originating scenario, even if the subscriber does not have “originating” unregistered services. In the second solution implemented in the second embodiment of the invention, if the subscriber is not registered to the IMS, then the home subscriber server always provides the Server-Capabilities AVP in a location information response message, even if the subscriber does not have unregistered services. To implement the second solution, no extensions of Cx messages are needed, as the only change is in the home subscriber server's behaviour. No change is also needed in the I-CSCF procedures of handling the location information answer messages, thus this solution is backward compatible for I-CSCF.

One possible method for implementing the second embodiment of the invention is for the application server to indicate an originating scenario to the I-CSCF by putting the ORIG flag as a URI parameter in a Request-URI of SIP message. The Request-URI of SIP message is parsed by the I-CSCF according to normal I-CSCF procedures. If this method is used, then the I-CSCF removes the ORIG flag from the Request-URI of SIP message.

In the second embodiment, operators may define a dedicated I-CSCF (configured in application servers) that serves only originating requests for unregistered services and that does not have S-CSCF selection based capabilities. In the application server, is must be ensured that the I-CSCF supports this functionality.

Another possible implementation method of the second embodiment is to define a new SIP header or define a new parameter for the P-Asserted-Identity header, which includes an identifier of the subscriber. If this method is chosen, then the I-CSCF has to parse the additional SIP header as part of its normal procedure in order for it to decide if the originating request is being served. The location information request message of the Cx interface should be extended with a new AVP that includes an indication of whether the location information request is made for an originating request. The new AVP may be optional, thus an I-CSCF not supporting the extension of the Cx interface may still work with this solution. Another alternative is to extend the existing Public-Identity AVP with the information on whether a location information query is requested for the originating request.

The first embodiment requires that the S-CSCFs addresses and the capabilitites supported by those S-CSCFs are configured to each application server that would like to originate requests on behalf of a subscriber. Also, the same S-CSCF selection logic is implemented to each application server, otherwise already available in the I-CSCF. With the first embodiment, one less role is involved in processing of originating requests and no modification is needed to the SIP. However, configuring S-CSCF information to the applications server might not be preferred by operators due to trust issues.

The second embodiment relies on the I-CSCF's existing capability for the S-CSCF selection. No additional configuration is needed for the application server, no capability based S-CSCF selection is needed in the application server, although change is required in the SIP protocol and in I-CSCF behaviour. The first solution implemented in the first and second embodiments requires introduction of new AVP or change of existing Public-Identity AVP to the location information request Cx message. In this solution, change is required both in the I-CSCF and home subscriber server implementation, thus this solution is not backward compatible for the I-CSCF and home subscribe server. The second solution implemented in the first and second embodiments does not require change in the Cx message; it only requires change in the home subscriber server's implementation; thus, this solution is backward compatible for the I-CSCF.

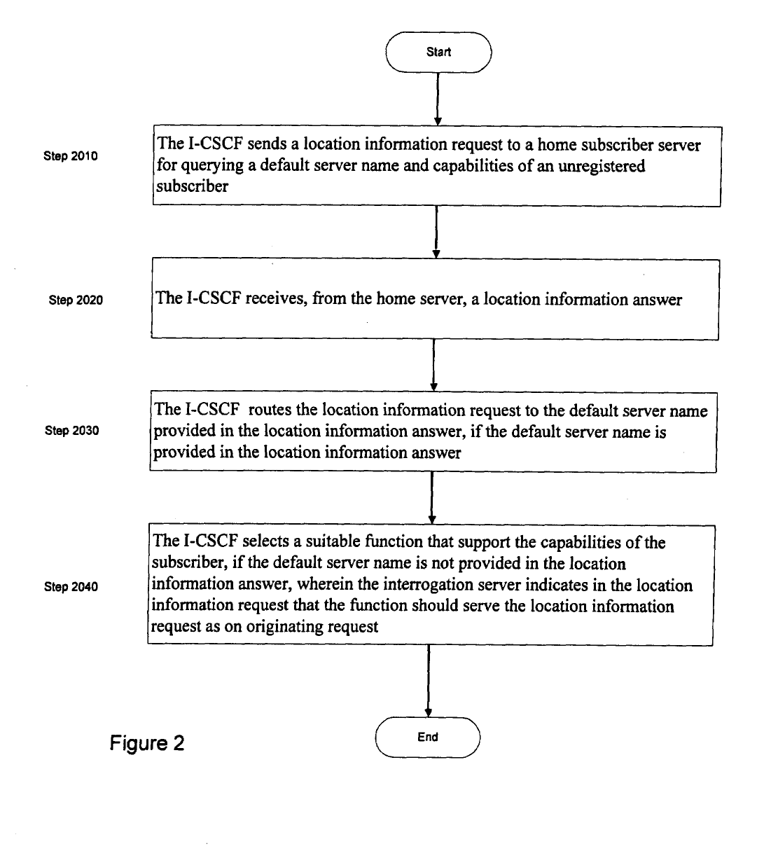

FIG. 2 illustrates steps implemented in a server implementing the invention. In Step 2010, the I-CSCF sends a location information request to a home subscriber server for querying a default server name and capabilities of an unregistered subscriber. In Step 2020, the I-CSCF receives, from the home server, a location information answer. In Step 2030, the I-CSCF routes the location information request to the default server name provided in the location information answer, if the default server name is provided in the location information answer. In Step 2040, the I-CSCF selects a suitable function that support the capabilities of the subscriber, if the default server name is not provided in the location information answer, wherein the interrogation server indicates in the location information request that the function should serve the location information request as on originating request.

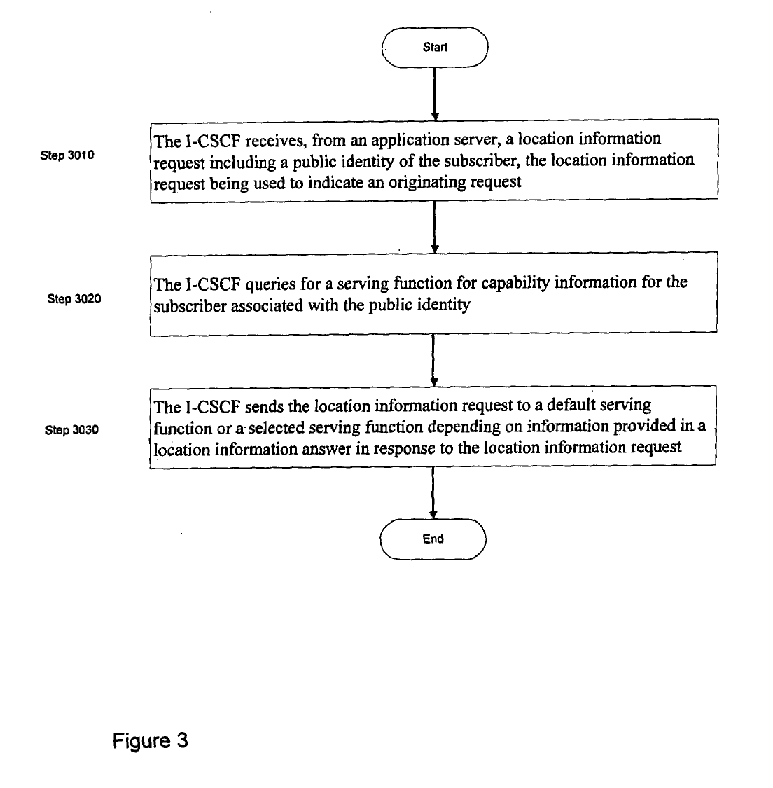

FIG. 3 illustrates the steps implemented by the I-CSCF implementing the invention. In Step 3010, the I-CSCF receives, from an application server, a location information request including a public identity of the subscriber, the location information request being used to indicate an originating request. In Step 3020, the I-CSCF queries for a serving function for capability information for the subscriber associated with the public identity. In Step 3030, the I-CSCF sends the location information request to a default serving function or a selected serving function depending on information provided in a location information answer in response to the location information request.

It should be appreciated by one skilled in art, that the present invention may be utilized in any device that implements the network availability information described above. The foregoing description has been directed to specific embodiments of this invention. It will be apparent; however, that other variations and modifications may be made to the described embodiments, with the attainment of some or all of their advantages. Therefore, it is the object of the appended claims to cover all such variations and modifications as come within the true spirit and scope of the invention.

1. A server comprising:
a sending unit configured to send a location information request to a home server for querying a default server name and capabilities of a unregistered subscriber for whom the server is originating the location information request;
a processing unit, if the default server name is provided in a location information answer, configured to route the location information request to the default server name provided in the location information answer or configured to select a suitable function and supported capabilities of the selected function; and
an indicating unit configured to indicate in the location information request that the function should serve the location information request as an originating request.

2. The server of claim 1, wherein the sending unit is configured to send the location information message though an existing interface.

3. The server of claim 1, wherein the processing unit is configured to select a suitable Serving Call Session Control Function.

4. The server of claim 3, wherein the indicating unit is configured to indicate in the location information request that the function should serve the location information request as an originating request by putting an originating parameter in the URI of the Serving Call Session Control Function.

5. The server of claim 1, wherein the processing unit is configured, if the location information request indicates that the function should serve the location information request as an originating request, to receive an attribute value pair in the location information answer even if the subscriber does not have originating unregistered services.

6. The server of claim 1, wherein the processing unit is configured to receive an attribute value pair in the location information answer

7. An interrogating-call session control function, comprising:
a receiving unit configured to receive a location information request including a public identity of an unregistered subscriber, the location information request being used to indicate an originating request;
an obtaining unit configured to obtain the public identity from the location information request;
a processing unit configured to query a home server for capability information for the subscriber associated with the public identity; and
a sending unit configured to send, upon receipt of a location information answer from the home server, the location information request to a default serving function or a selected serving function, depending on information provided in the location information answer in response to the location information request.

8. The interrogating-call session control function of claim 7, wherein the processing unit is configured to send the location information request to the home server using the public identity of the subscriber.

9. The interrogating-call session control function of claim 7, wherein the sending unit is configured to send the location information request to a selected serving function based on the capabilities in the location information answer.

10. The interrogating-call session control function of claim 7, wherein the location information request is used to indicate an originating request by placing an originating parameter in the URI of a Serving Call Session Control Function.

11. The interrogating-call session control function of claim 7, wherein the receiving unit is configured to receive the location information request, wherein the location information request includes an originating parameter to a URI of the interrogating-call session control function that is added to the location information request in a topmost route header.

12. The interrogating-call session control function of claim 7, wherein the processing unit is configured, if the location information request indicates that the function should serve the location information request as an originating request, to receive an attribute value pair in the location information answer even if the subscriber does not have originating unregistered services.

13. The interrogating-call session control function of claim 7, wherein the processing unit is configured to receive an attribute value pair in the location information answer

14. A method comprising:
sending, by an interrogation server, a location information request to a home server for querying a default server name and capabilities of an unregistered subscriber;
receiving, by the interrogation server from the home server, a location information answer;
routing, by the interrogation server, the location information request to the default server name provided in the location information answer, if the default server name is provided in the location information answer; and
selecting, by the interrogation server, a suitable function that support the capabilities of the subscriber, if the default server name is not provided in the location information answer, wherein the interrogation server indicates in the location information request that the function should serve the location information request as on originating request.

15. The method of claim 14, wherein sending the location information request comprises sending the location information request though an existing interface.

16. The method of claim 14, wherein selecting a suitable function comprises selecting a suitable Serving Call Session Control Function.

17. The method of claim 16, wherein the indicating in the location information request that the function should serve the location information request as an originating request comprises placing an originating parameter in the URI of the Serving Call Session Control Function.

18. The method of claim 14, wherein receiving a location information answer comprises receiving an attribute value pair in the location information answer even if the subscriber does not have originating unregistered services, if the location information request indicates that the function should serve the location information request as an originating request.

19. The method of claim 14, wherein receiving a location information answer comprises receiving an attribute value pair in the location information answer

20. A method comprising:
receiving, by an interrogation function from an application server, a location information request including a public identity of the subscriber, the location information request being used to indicate an originating request;
querying a home server for capability information for the subscriber associated with the public identity;
sending the location information request to a default serving function or a selected serving function depending on information provided in a location information answer in response to the location information request.

21. The method of claim 20, wherein querying for a serving function comprises send the location information request to a home server using the public identity of the subscriber.

22. The method of claim 20, further comprising using the location information request to indicate an originating request by placing an originating parameter in the URI of a Serving Call Session Control Function.

23. The method of claim 20, further comprising using the location information request to indicate an originating request by placing an originating parameter in a route header of the interrogating-call session control function.

24. The method of claim 20, further comprising, if the location information request indicates that the function should serve the location information request as an originating request, receiving an attribute value pair in the location information answer even if the subscriber does not have originating unregistered services.

25. The method of claim 20, further comprising receiving an attribute value pair in the location information answer

26. An apparatus, comprising:
sending means for sending, by an interrogation server, a location information request to a home server for querying a default server name and capabilities of an unregistered subscriber;
receiving means for receiving, by the interrogation server from the home server, a location information answer;
routing means for routing, by the interrogation server, the location information request to the default server name provided in the location information answer, if the default server name is provided in the location information answer; and
selecting means for selecting a suitable function that support the capabilities of the subscriber, if the default server name is not provided in the location information answer, wherein the interrogation server indicates in the location information request that the function should serve the location information request as on originating request.

27. An apparatus, comprising:
receiving means for receiving, by an interrogation function from an application server, a location information request including a public identity of the subscriber, the location information request being used to indicate an originating request;
querying means for querying, by the interrogation function, a home server for capability information for the subscriber associated with the public identity; and
sending means for sending, by the interrogation function, the location information request to a default serving function or a selected serving function depending on information provided in a location information answer in response to the location information request.
